(19) United States
(12) Patent Application Publication
(10) Pub. No.: US 2019/0028314 A1
(43) Pub. Date: Jan. 24, 2019

(54) WIRELESS DATA COMMUNICATION BASED ON DISCRETE COSINE TRANSFORMATION

(71) Applicants: ZTE Wistron Telecom AB, Kista (SE); ZTE (TX) INC., Austin, TX (US)

(72) Inventors: Aijun CAO, Kista (SE); Adnan ZAFAR, Kista (SE); Chang HE, Kista (SE); Pei XIAO, Kista (SE); Muhammad IMRAN, Kista (SE); Yonghong GAO, Kista (SE); Jan JOHANSSON, Kista (SE)

(21) Appl. No.: 16/067,071

(22) PCT Filed: Jan. 5, 2017
(86) PCT No.: PCT/US2017/012376

§ 371 Date: Jun. 28, 2018

Related U.S. Application Data
(60) Provisional application No. 62/275,162, filed on Jan. 5, 2016.

(51) Int. Cl. H04L 27/26; H04L 27/34

(52) U.S. Cl. CPC H04L 27/2639; H04L 27/2697; H04L 5/0023; H04L 27/2605; H04L 27/34

(57) ABSTRACT

A method of performing fast orthogonal frequency division multiplexing (FOFDM) includes: receiving a symbol transmitted in a multi-carrier communication system, wherein the symbol represents at least part of a transmitted signal, wherein the symbol is modulated based on a discrete cosine transform (DCT) technique; and estimating the symbol by using a widely linear (WL) estimation technique to minimize a difference between the received symbol and the estimated symbol.

### CROSS-REFERENCE TO RELATED APPLICATION

This application is a 371 of International Application No. PCT/US2017/012376, filed on Jan. 5, 2017 which claims benefit of U.S. Provisional Application No. 62/275,162, filed on Jan. 5, 2016, which are incorporated by reference herein in their entireties.

### FIELD OF THE INVENTION

The present invention relates generally to methods for data transmission in various types of wireless communication systems, and in particular to systems and methods for transmitting/receiving data via discrete cosine transform (DCT)-based signals.

### BACKGROUND OF THE INVENTION

After several decades of evolution, e.g., from 2G, 3G and 4G, and now approaching to 5G, mobile networks are able to provide billions of mobile users with data transmission service via almost ubiquitous radio access. For data modulation schemes via radio transmission, there are generally two types: SCM (Single Carrier Modulation) and MCM (Multi-Carrier Modulation). Compared to SCM, MCM divides a wide frequency band into a number of parallel subcarriers, and each subcarrier handles narrow-banded transmission and reception of signals. Therefore, MCM provides excellent merits for achieving good spectrum efficiency while at the same time having a relatively low implementation complexity. For example, as a special kind of multi-carrier modulation scheme, OFDM (Orthogonal Frequency Division Multiplex) is widely used in many modern communication standards, e.g., WLAN (Wireless Local Access Network), LTE (Long-Term Evolution), and even optical transmission systems.

Fast OFDM (FOFDM) is a promising multicarrier technique that can provide twice the data rate compared to conventional OFDM techniques. FOFDM systems utilize one dimensional symbols (real-valued symbols) for transmission in various embodiments. This reduces the required subcarrier spacing to half that of conventional OFDM systems, which in turn leads to a promising multicarrier system with high data rate capability. Unlike the OFDM systems that employ discrete Fourier transform (DFT), the FOFDM system adopts the discrete cosine transform (DCT) function for multiplexing the symbols on the subcarriers. This also reduces the complexity of the FOFDM system as DCT only uses real-valued arithmetic operations as opposed to the requirement of performing complex-valued arithmetic operations in DFT as used by the OFDM systems. As such, complexity and power consumption of a transmitter of the FOFDM system may be substantially reduced. Additionally, inter-carrier interference (ICI) coefficients in a DCT-based multicarrier system (e.g., FOFDM systems) are more concentrated around the main coefficient than in a DFT based multicarrier system, resulting in better improved robustness against frequency offsets. Since only one-dimensional modulation is used for many FOFDM systems, phase estimation in coherent detection at a receiver end of the FOFDM system is also simplified. For example, a data rate of about 14.348 Gbit/s can be achievable in an optical FOFDM system.

However, one challenge for FOFDM system is an equalization issue under frequency-selective channels due to lack of a circular convolution property in the DCT transform. As a consequence, a channel cannot be easily compensated by single-tap equalization in FOFDM systems unless the channel impulse response (CIR) is symmetric. Two methods have been proposed in literature that enable FOFDM to support single-tap equalization at the receiver. The first approach involves zero-padding instead of cyclic prefix but may in turn lead to intercarrier interference. The second method involves inserting a prefix and a suffix into each data symbol block at the transmitter while a pre-filter is imposed at the front end of the receiver to achieve symmetric channel impulse response (CIR). This second method, however, may require higher complexity or additional circuit elements to be included in the transmitter and/or receiver. Thus, conventional FOFDM systems are not entirely satisfactory.

### SUMMARY OF THE INVENTION

A DCT based multicarrier system, also known as fast orthogonal frequency division multiplexing (FOFDM), is a promising multicarrier transmission technique that requires half the subcarrier spacing compared to conventional OFDM technique. The signal processing complexity and power consumption of such systems are also reduced due to the system's real arithmetic operations compared to DFT based system (OFDM) that require complex arithmetic operations. However, unlike OFDM, FOFDM uses a finite impulse response (FIR) front-end pre-filter at the receiver to achieve single-tap equalization for simplifying the receiver design. The receiver design can be further improved using the fact that a FOFDM system transmits real valued symbols compared to complex valued symbols transmitted by conventional OFDM systems. This fact enables an improvement in system performance by exploiting the improperness of such DCT based multicarrier signals using widely linear processing (WLP).

In various embodiments of the disclosed invention, a novel equalization technique using WLP is provided for use in DCT multicarrier modulation. The technique effectively improves the system performance, and it is shown that the disclosed FOFDM receiver can provide better estimates of the transmitted symbols and outperforms its OFDM counterpart.

### BRIEF DESCRIPTION OF THE DRAWINGS

The present invention, in accordance with one or more various embodiments, is described in detail with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily made to scale.

FIG. 1 illustrates a schematic diagram of a widely linear estimator, in accordance with various embodiments of the present disclosure.

FIG. 2 illustrates a block diagram of a fast orthogonal frequency division multiplexing (FOFDM) system, in accordance with various embodiments of the present disclosure.

FIG. 3 illustrates an exemplary bit error rate (BER) performance of the FOFDM system of FIG. 2, in accordance with various embodiments of the present disclosure.

FIG. 4 illustrates an exemplary mean square error (MSE) estimation of the FOFDM system of FIG. 2, in accordance with various embodiments of the present disclosure.

### DETAILED DESCRIPTION OF EXEMPLARY EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

In the following description of exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

Embodiments of the present disclosure are directed to exploiting the improperness of FOFDM signals using widely linear filtering and in various embodiments, one contribution in this regard is related to the determination and investigation of how widely linear receivers affect the FOFDM system performance. In various embodiments, the performance is evaluated by measuring the mean square error (MSE) and bit error rate (BER) of a FOFDM system under frequency selective channel conditions and the results are compared with conventional linear processing.

Classical linear signal processing techniques are widely used in wireless communication systems that employ circular (or proper) signals, e.g., M-ary Phase Shift Keying (MPSK), M-ary Quadrature Amplitude Modulation (MQAM), etc. However, in various cases, transmitted signals are non-circular (or improper), e.g., Amplitude Shift Keying (ASK), Offset Quadrature Amplitude (OQAM), etc. In such cases, the linear processing technique does not take into account all second order statistics of the received signal and therefore the estimation at a receiver is suboptimal. Widely linear processing (WLP) takes advantage of the improperness of these signals, by processing the signal together with its conjugate version to obtain a more precise estimate at the receiver.

To understand the “improperness” referred to above, we define a complex-valued random vector s as s=s_{I}+js_{Q}ϵ [symbol] ^{(N×1)}, where s_{I}, s_{Q} are real-valued random vectors, i.e., s_{I}, s_{Q}ϵ [symbol] ^{(N×1)} with zero mean. In various embodiments, the second order statistics of “s” are defined by using the autocorrelation matrix (Rₛₛ) and pseudo-autocorrelation matrix (R_{ss*}), wherein Rₛₛ=E{ss^{H}} and R_{ss*}=E{ss^{T}}, respectively. E(⋅) is an expectation operator. In order for s to be proper or circular, the complete second order statistics of s should be completely defined by Rₛₛ only. But if the second order statistics are described by both Rₛₛ and R_{ss*}, then the complex random vector s will be improper/non-circular. The improperness of such random vectors can be exploited using widely linear processing (WLP) at the receiver, in accordance with various embodiments.

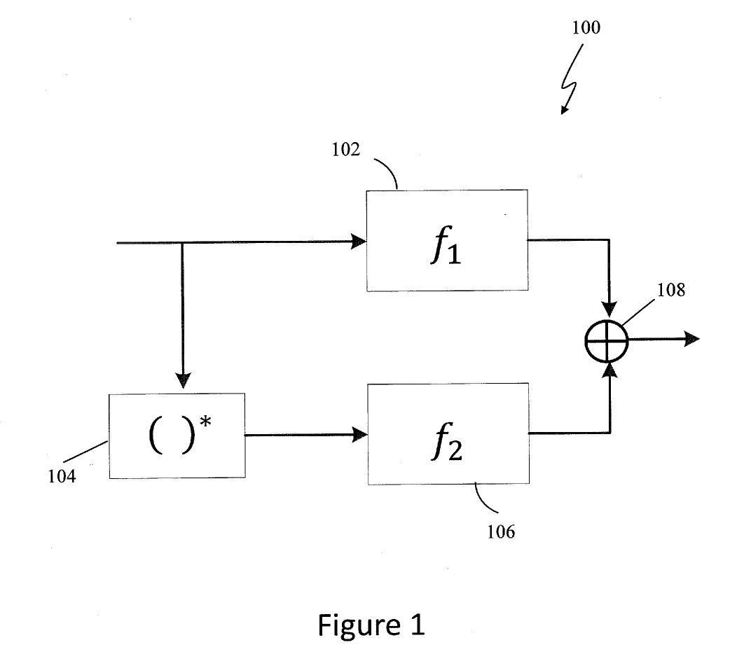

In various embodiments, the receiver with WLP includes a widely linear minimum mean square error (WL-MMSE) estimator. In various embodiments, the estimator makes use of the received data r=Hs+n and its conjugate version r* to estimate the transmitted symbol s, where H is the channel matrix and n is the Gaussian noise. An exemplary block diagram of the WL-MMSE estimator according to one embodiment is illustrated in FIG. 1.

FIG. 1 illustrates a schematic diagram of a widely linear (WL) estimator 100, in accordance with various embodiments of the present disclosure. As shown in FIG. 1, the estimator 100 includes a first filter 102 (hereinafter filter “f₁”), a second filter 104 (hereinafter filter “f₂”), a conjugate operator 104, and an adder 108. In some embodiments, the first filter f₁ is configured to receive the received data r and perform a filtering function on the received data r; the conjugate operator 104 is configured to conjugate the received data r; the second filter f₂ is configured to perform another filtering function on the conjugated data; and the multiplexer 108 is configured to convolute filtered signals provided by the first and second filters f₁ and f₂, respectively, so as to provide an estimated symbol vector ŝ, which will be discussed in further detail below.

In some embodiments, the expression for the WL estimator can be written as (1)

ŝ=f^{H}₁r+f^{H}₂r* (1)

where f₁ and f₂ are two receive filters, and are designed in order to minimize a mean square error between the transmitted symbol vector s and the estimated symbol vector ŝ. In various embodiments, the filter f₁ and f₂ are vectors and may be obtained using (2)

$$[ \begin{matrix}{f}_{1} \\ {f}_{2}\end{matrix} ] = {[ \begin{matrix}{R}_{rr} & {R}_{{rr}^{*}} \\ {R}_{{rr}^{*}}^{*} & {R}_{rr}^{*}\end{matrix} ]}^{- 1} [ \begin{matrix}{r}_{s} \\ {r}_{v}^{*}\end{matrix} ] \qquad ( 2 )$$

where Rᵣᵣ=E[rr^{H}]=HRₛₛH^{H}+NₒI is the autocorrelation matrix, R_{rr*}=E[rr^{T}]=HR_{ss*}H^{T} is the pseudo-correlation matrix and finally rₛ=E[s*r]=HR_{ss*} and rᵥ=E[sr]=HRₛₛ. The solution to (2) may be given as (3) and (4)

f₁=[Rᵣᵣ−R_{rr*}(R*ᵣᵣ)⁻¹R*_{rr*}]⁻¹[rₛ−R_{rr*}(R*ᵣᵣ)⁻¹r*ᵥ] (3)

f₂=[R*ᵣᵣ−R*_{rr*}(Rᵣᵣ)⁻¹R_{rr*}]⁻¹[r*ᵥ−R*_{rr*}(Rᵣᵣ)⁻¹rₛ] (4)

The widely linear filters f₁ and f₂ together with the received vector r and its conjugate version r* advantageously provide a more precise estimate of the transmitted signal s compared to a linear processing technique as the difference Δ [symbol] given as (5) between mean square error of a linear estimator [symbol] _{L-MMSE} and widely linear estimator Δ [symbol] _{WL-MMSE} is always non-negative.

Δ [symbol] =[r*ᵥ−R*_{rr*}(Rᵣᵣ)⁻¹rₛ]^{H}[R*ᵣᵣ−R*_{rr*}(Rᵣᵣ)⁻¹R_{rr*}]⁻¹[r*ᵥ−R*_{rr*}(Rᵣᵣ)⁻¹rₛ] (5)

This is at least partially because the matrix [R*ᵣᵣ−R*_{rr*}(Rᵣᵣ)⁻¹R_{rr*}] is positive definite and Δ [symbol] =0 only when the matrix [r*ᵥ−R*_{rr*}(Rᵣᵣ)⁻¹rₛ]=0. Therefore [symbol] _{L-MMSE}≥ [symbol] _{WL-MMSE} and the WL estimator advantageously gives a more precise estimation of the transmitted signal s when compared to linear estimators.

Embodiments of the disclosure provide DCT-based FOFDM through the use of a front-end filter at the receiver to keep ICI and inter-symbol interference (ISI) free transmission while achieving simpler equalization at the same time.

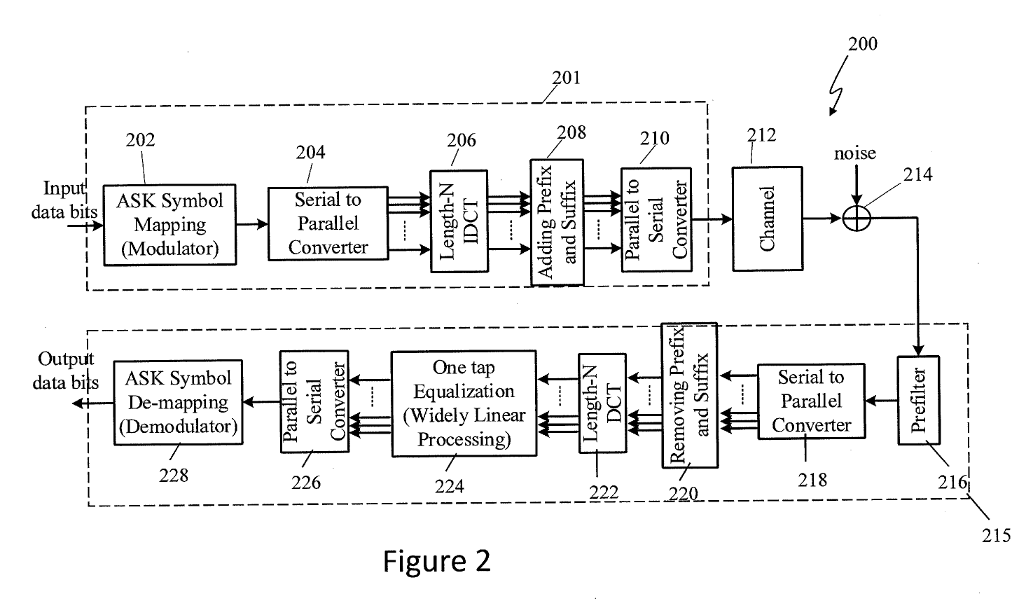

FIG. 2 provides an exemplary block diagram of such a FOFDM system 200 according to various embodiments of the disclosure. The FOFDM system 200 includes a transmitter 201 and a receiver 215. The transmitter 201 is configured to receive “input data bits,” and modulate the input data bits through any of a variety of modulation techniques to provide a modulated signal for a channel 212 to transmit. When the modulated signal is transmitted via the channel 212, “noise” may be induced. Such noise is added to the transmitted signal via an adder 214. The is received by the receiver 215 for demodulation. After the receiver 215 finishes the demodulation, the receiver 215 is configured to provide “output data bits.”

Referring still to FIG. 2, in some embodiments, the transmitter 201 includes a modulator 202 configured to map the input data bits into one or more symbols using a variety of modulation techniques (e.g., an amplitude-shift keying (ASK) technique, an offset quadrature amplitude (OQAM) technique, etc.), a serial-to-parallel converter 204 configured to convert serial-in signals to plural parallel-out signals, an inverse DCT converter 206 configured to perform an inverse DCT on each of the parallel signals, a symbol modifier 208 configured to add a prefix and/or a suffix to a received symbol, and a parallel-to-serial converter 210 configured to convert plural parallel-in signals into serial-out signals.

On the reception end, the receiver 215 includes a pre-filter 216 configured to perform a pre-filtering function on a received signal (e.g., the transmitted signal with the noise), a serial-to-parallel converter 218 configured to convert serial-in signals into plural parallel-out signals, a symbol modifier 220 configured to remove a prefix and/or a suffix from a received symbol, a DCT converter 222 configured to perform a DCT on each of the parallel signals, an equalizer 224 configured to perform the WL estimation described with respect to FIG. 1, a parallel-to-serial converter 226 configured to convert plural parallel-in signals into serial-out signals, and a demodulator 228 configured to demodulate symbols and de-map the symbols into the output data bits.

The following disclosed method performed by the system of FIG. 2 is provided by way of example and various variations of the method of FIG. 2 are used in other embodiments. According to various embodiments, the complete DCT based multicarrier system shown in FIG. 2 can be modeled as (6)

$$y = \frac{1}{γ} DRPHCDHs + DRPn , \qquad ( 6 )$$

where y is the signal received at an input of the equalizer (i.e., the one tap equalization block in FIG. 2), s∈ [symbol] ^{(N×1)} is the transmitted real symbol vector with normalized power. D∈ [symbol] ^{(N×N)} is power normalized DCT matrix. C∈ [symbol] ^{(L}^{₁}^{×N)} is the matrix implementation of adding prefix (Lₚ) and suffix (Lₛ), and is represented as follows:

C=[I_{L}_{_{P}}J_{L}_{_{P}},0_{L}_{_{P}}_{×(N-L}_{_{P}}₎;I_{N};0_{L}_{ₛ}_{×(N-L}_{ₛ}₎,I_{L}_{ₛ}J_{L}_{ₛ}]

where I_{L}_{_{P}} is an identity matrix and J_{L}_{_{P}} is a reversal matrix each of dimension L_{P}, 0_{L}_{_{P}}_{×(N-L}_{_{P}}₎ is a zero matrix of size L_{P}×(N−L_{P}), and L₁=N+L_{P}+Lₛ. H∈ [symbol] ^{(L}^{₁}^{×L}^{₁}⁾ is a channel convolution matrix, which is a Toeplitz matrix with the first row and first column defined as [g; 0_{1×(L}_{₁}_{-L)}] and [h_{L}; 0_{1×(L}_{₁}₋₁₎]^{T} respectively, and wherein h=[h₁, h₂, . . . , h_{L}] is a channel impulse response, and g=[g₁, g₂, . . . , g_{L}]=[h_{L}, h_{L-1}, . . . , h₁]. P∈ [symbol] ^{(L}^{₁}^{×L}^{₁}⁾ is the Toeplitz matrix with first row and column defined as [h_{L}; 0_{1×(L}_{₁}₋₁₎] and [g; 0_{1×(L}_{₁}_{-L)}]^{T} respectively. R∈ [symbol] ^{(N×L}^{₁}⁾ is a matrix implementation form of removing the prefix and suffix and is defined as follows.

R=[0_{N×L}_{_{P}};I_{N};0_{N×L}_{ₛ}]

γ is the power normalization factor defined as (assuming s is normalized) follows.

$$γ = \sqrt{\frac{1}{N} {traceDC}^{H} {CD}^{H}} = \sqrt{\frac{{L}_{1}}{N}}$$

From the system model defined in (6), the effective channel matrix H_{eff}∈ [symbol] ^{(N×N)} may be written as follows.

H_{eff}=DRPHCDH (7)

The noise variance of the system is also changed because of the prefiltering operation. The prefiltering of the noise is represented as (8)

v=DR(Pᵣnᵣ+jPᵢnᵢ) (8)

where Pᵣ and Pᵢ are the real and imaginary parts of the prefiltering matrix P and nᵣ and nᵢ are the real and imaginary parts of the noise vector n. This n is the actual additive white Gaussian noise (AWGN) with variance σ²ₙ. This original σ²ₙ depends upon the modulation type (m), code rate (R_{c}), length of prefix (L_{P}) and length of suffix (L₅) as they directly affect the average bit energy and consequently the E_{b}/Nₒ of the system.

The original σ²ₙ may be calculated using (9).

$${σ}_{n}^{2} = \frac{{E}_{s}}{α {mR}_{c}} {10}^{\frac{- {E}_{b} / {N}_{o}}{10}} , \qquad ( 9 )$$

where Eₛ is the average symbol energy which is assumed to be unit i.e. Rₛₛ=E[|sₖ|²]=1, α is the SNR reduction factor and its value is

$$α = \frac{N}{{L}_{P} + N + {L}_{s}} .$$

The effective noise variance is E{vv^{H}} and in various embodiments, the effective noise variance E{vv^{H}} after the prefilter can be expressed as follows:

$$\begin{matrix}E \{ {vv}^{H} \} = E \{ DR ( {P}_{r} {n}_{r} + j {P}_{i} {n}_{i} ) {( {P}_{r} {n}_{r} + {jP}_{i} {n}_{i} )}^{H} {R}^{H} {D}^{H} \} \\ = E \{ DR ( {P}_{r} {n}_{r} + j {P}_{i} {n}_{i} ) ( {n}_{r}^{H} {P}_{r}^{H} - {jn}_{i}^{H} {P}_{i}^{H} ) {R}^{H} {D}^{H} \} \\ = E \{ DR ( {P}_{r} {n}_{r} {n}_{r}^{H} {P}_{r}^{H} + {P}_{i} {n}_{i} {n}_{i}^{H} {P}_{i}^{H} ) {R}^{H} {D}^{H} \} \\ = E \{ DR ( {P}_{r} E \{ {n}_{r} {n}_{r}^{H} \} {P}_{r}^{H} + {P}_{i} E \{ {n}_{i} {n}_{i}^{H} \} {P}_{i}^{H} ) {R}^{H} {D}^{H} \}\end{matrix} \qquad ( 10 )$$

### As

$$\{ {n}_{r} {n}_{r}^{H} \} = E \{ {n}_{i} {n}_{i}^{H} \} = \frac{{σ}_{n}^{2}}{2} .$$

(10) as (11) may be written as:

$$\begin{matrix}E \{ {vv}^{H} \} = DR [ \frac{{σ}_{n}^{2}}{2} E \{ {P}_{r} {P}_{r}^{H} \} + \frac{{σ}_{n}^{2}}{2} E \{ {P}_{i} {P}_{i}^{H} \} ] {R}^{H} {D}^{H} \\ = \frac{{σ}_{n}^{2}}{2} DR [ E \{ {P}_{r} {P}_{r}^{H} \} + E \{ {P}_{i} {P}_{i}^{H} \} ] {R}^{H} {D}^{H} \\ = \frac{{σ}_{n}^{2}}{2} DRE \{ {PP}^{H} \} {R}^{H} {D}^{H}\end{matrix} \qquad ( 11 )$$

As the elements of P consist of channel impulse response hᵢ with E{hᵢh^{H}ᵢ}=0 when i≠j. E{PP^{H}}=T=diag(t) may thus be defined. The elements of vector t=[t₁, t₂, . . . , t_{L}_{₁}] are calculated as follows.

$${t}_{m} = \{ \begin{matrix}{\sum }_{i = 1}^{M} E {\vert {g}_{i} \vert}^{2} & 1 \leq m \leq L \\ {\sum }_{i = 1}^{L} E {\vert {g}_{i} \vert}^{2} & L < m < {L}_{1}\end{matrix} \qquad ( 12 )$$

So (11) may be written as follows.

$$E \{ {vv}^{H} \} = \frac{{σ}_{n}^{2}}{2} DRTRHDH$$

The effective noise variance N_{eff} at the N different subcarriers can be reframed as the following diagonal matrix.

$${N}_{eff} = \frac{{σ}_{n}^{2}}{2} diag ( DRTRHDH ) \qquad ( 13 )$$

The H_{eff} from (7) and N_{eff} from (13) is used for the design of the widely linear receive filters f₁ and f₂ according to equation (3) and (4).

Simulation parameters according to one embodiment, are given in Table. I

TABLE I
Simulation Parameters

| | | | |
|---|---|---|---|
| FFT Size (N) | 64 | Blocks/Frame (N_{sym}) | 10 |
| Prefix & Suffix (Lp, Ls) | 12 | Modulation (m) | ASK |

Channel Type: 802:11 Multipath Channel

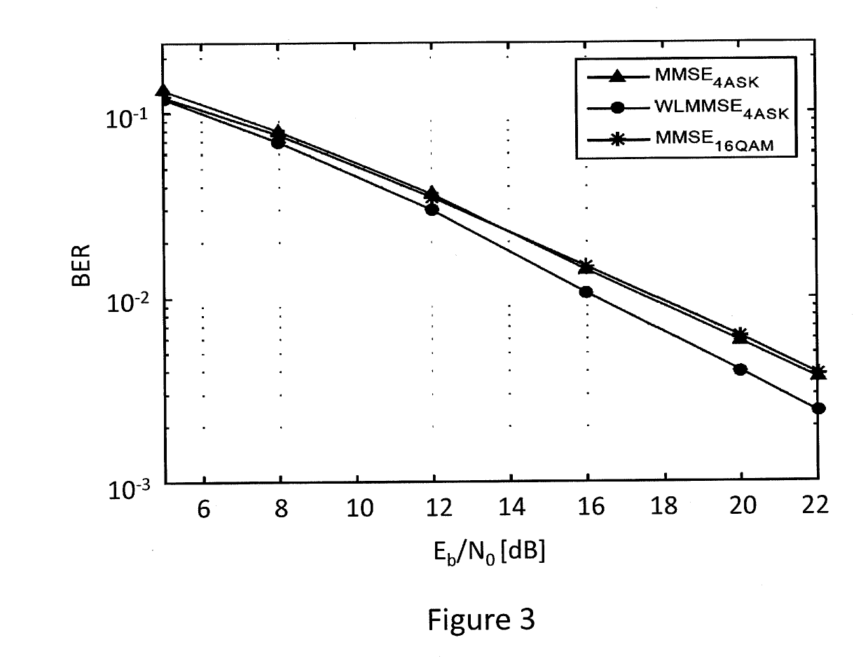

The results have shown that WL (widely linear) filtering can significantly improve the BER performance of the DCT based multicarrier system due to its inherent property of generating improper signals. The bit error rate (BER) performance of an exemplary system can be seen from FIG. 3.

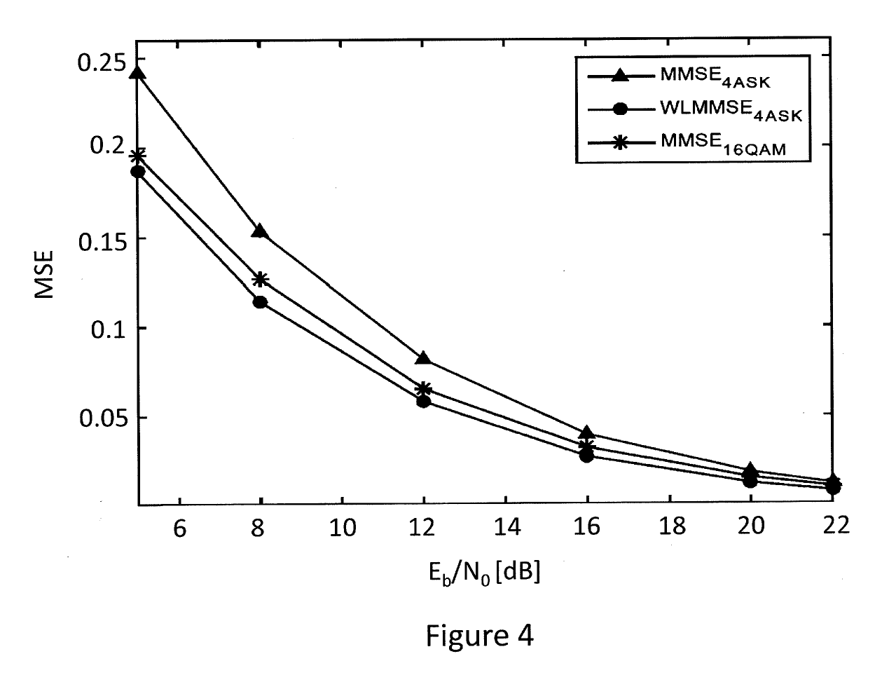

It can be observed from FIG. 4 that the mean square error (MSE) performance is also better in the WL case, i.e., WLMMSE (widely linear minimum mean square error estimator), compared to its linear counterpart. This leads to a more precise estimate of the transmitted symbols. The comparison between OFDM and FOFDM is based on the assumption that two systems achieve the same transmission rate. In each of FIGS. 3 and 4, 4ASK is used for FOFDM embodiments, and 16QAM is used for the OFDM embodiment.

While one or more embodiments of the invention have been described above, it should be understood that they have been presented by way of example only, and not by way of limitation. Likewise, the various figures or diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations.

One of ordinary skill in the art will recognize that the functions described herein can be performed by one or more processors contained in the UE, the device, the TP(s), or in a base station in the case of corresponding base station functions. Thus, one or more of the functions described in this document may be performed by an appropriately configured processor. In accordance with various embodiments, the processor may be implemented as a single integrated circuit (IC) or as multiple communicatively coupled IC's and/or discrete circuits. It is appreciated that the processor can be implemented in accordance with various known technologies. In one embodiment, the processor includes one or more circuits or units configurable to perform one or more functions or processes described herein by executing instructions stored in an associated memory, for example. In other embodiments, the processor may be implemented as firmware (e.g., discrete logic components) configured to perform one or more functions or processes described herein. For example, in accordance with various embodiments, the processor may include one or more controllers, microprocessors, microcontrollers, application specific integrated circuits (ASICs), digital signal processors, programmable logic devices, field programmable gate arrays, or any combination of these devices or structures, or other known devices and structures, to perform the functions described herein.

Additionally, one or more of the functions described in this document may be performed by means of computer program code that is stored in a “computer program product”, “computer-readable medium”, and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional layers or modules. However, it will be apparent that any suitable distribution of functionality between different functional units, processors or domains may be used without departing from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments but instead be given the scope commensurate with the plain and ordinary meaning of the claims.

What is claimed is:

1. A method of performing fast orthogonal frequency division multiplexing (FOFDM) comprising:
receiving a symbol transmitted in a multi-carrier communication system, wherein the symbol represents at least part of a transmitted signal, wherein the symbol is modulated based on a discrete cosine transform (DCT) technique; and
estimating the symbol by using a widely linear (WL) estimation technique to minimize a difference between the received symbol and the estimated symbol.

2. The method of claim 1, wherein the using the WL estimation technique includes using a first filter vector and a second filter vector based on an autocorrelation matrix and a pseudo-correlation matrix of the received symbol, respectively.

3. The method of claim 2, wherein the autocorrelation matrix is derived based on a channel matrix by which the received symbol is transmitted, and a noise matrix.

4. The method of claim 3, wherein the pseudo-correlation matrix is derived based on a transportation of the channel matrix.

5. The method of claim 3, wherein the channel matrix is based on a power normalized DCT matrix.

6. The method of claim 5, wherein the noise matrix is associated with a noise variance matrix that is based on a diagonal matrix of the power normalized DCT matrix.

7. The method of claim 1, wherein the received symbol includes an improper signal constellation.

8. A fast orthogonal frequency division multiplexing (FOFDM) communication system, comprising:
a transmitter configured to modulate a signal onto multiple carrier signals based on a discrete cosine transform (DCT) technique and provide at least part of the signal as a symbol;
a channel that is configured to transmit the symbol; and
a receiver configured to receive the symbol and estimate the symbol by using a widely linear (WL) estimation technique to minimize a difference between the received symbol and the estimated symbol.

9. The communication system of claim 8, wherein the receiver is further configured to use a first filter vector and a second filter vector are based on an autocorrelation matrix and a pseudo-correlation matrix of the received symbol to minimize the difference between the received symbol and the estimated symbol.

10. The communication system of claim 9, wherein the autocorrelation matrix is derived based on a channel matrix by which the received symbol is transmitted, and a noise matrix.

11. The communication system of claim 10, wherein the pseudo-correlation matrix is derived based on a transportation of the channel matrix.

12. The communication system of claim 10, wherein the channel matrix is based on a power normalized DCT matrix.

13. The communication system of claim 12, wherein the noise matrix is associated with a noise variance matrix that is based on a diagonal matrix of the power normalized DCT matrix.

14. The communication system of claim 8, wherein the received symbol includes an improper signal constellation.

15. The communication system of claim 8, wherein the transmitter is further configured to module the signal by using an amplitude-shift keying (ASK) technique and/or an offset quadrature amplitude (OQAM) technique.
